(19) United States
(12) Patent Application Publication
(10) Pub. No.: US 2017/0082517 A1
(43) Pub. Date: Mar. 23, 2017

(54) LEAK DETECTION SYSTEM

(71) Applicant: Gas Turbine Specialty Parts LLC, Avondale, AZ (US)

(72) Inventor: Victor Sanchez, Brea, CA (US)

(21) Appl. No.: 14/863,324

(22) Filed: Sep. 23, 2015

(51) Int. Cl. G01M 3/04

(52) U.S. Cl. CPC G01M 3/04

(57) ABSTRACT

A leak identification system includes a boundary containment system and a leak indicator system that enables quick identification of leaks within various systems.

### TECHNICAL FIELD

The present invention is generally related to identifying leaks in systems. More particularly, the present invention enables identifying the location of leaks of liquid and/or gas within a pipe-based or enclosed system.

### BACKGROUND

Leaks of gas and liquids occur in a variety of systems such as gas turbine such as gas turbine systems (including fuel gas supply and interconnects, false start drains and compressors), pumping systems, refrigeration systems, gas distribution systems and the like. Typically, once a leak occurs, the leak must be identified by entering hazardous areas to identify the location of the leak. In best practice, workers must wait for a particular system to be shut down and isolated, wait for the affected area to be safe, and then enter the hazardous environment to search for the offending leak. The process can quickly multiply into wasted hours per event and lost availability of the shut down system (e.g., gas turbines remain non-operational).

In searching for the leak, workers may have to visually inspect multiple flanges (e.g, gas turbines can have hundreds of potential flange leak locations within a turbine compartment) before repair work is conducted. Additional equipment may have to be utilized depending on the environment to detect the leaks. The leak locating process can easily be multiples of the actual repair process of a leak.

What is needed is a system to shorten the time to identify leaks, increase the safety of the leak identification process, or identify small leaks before they become major leaks, which cost product time or efficiency.

### SUMMARY

While the way in which the present invention addresses the disadvantages of the prior art will be discussed in greater detail below, in general, the present invention provides for identifying leaks in various systems. In particular, the present invention includes a boundary containment system attached to a leak indication system. In an exemplary embodiment, a sealed boundary is created around an area of interest, for example, a pipe flange assembly. Once the boundary is sealed, a leak indication system is sealed to the boundary containment system creating a completely sealed environment around an area of interest. Once a leak occurs, the leak indication system uses the increased pressure or flow from the leak in the boundary containment system to provide a notification at the location of the leak. The notification may be mechanical and/or digital, locally or remotely.

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description, or may be learned by the practice of the invention.

### BRIEF DESCRIPTION OF THE DRAWINGS

In order to describe the manner in which the advantages and features of the present invention can be obtained, a more particular description of the present invention will be rendered by reference to specific embodiments and examples, which are illustrated in the appended drawings. Understanding that these drawings depict only typical embodiments of the invention and are not therefore to be considered to be limiting of its scope, the present invention will be described and explained with additional specificity and detail through the use of the accompanying drawings in which:

FIG. 1 illustrates a side view of an exemplary leak detection system.

FIG. 2 illustrates an exemplary leak indicator system.

FIG. 3 illustrates exemplary flange seal types of the present invention.

FIG. 3A illustrates an exploded view of an alternative embodiment of a flange seal type of the present invention

FIG. 4 illustrates an alternative embodiment of a leak detection system.

FIG. 5 illustrates an alternative embodiment of a leak detection system that seals the cavity between flanges in a flange assembly.

### DETAILED DESCRIPTION

Various embodiments of the invention are described in detail below. A person skilled in the relevant art will recognize that other components and configurations may be easily used or substituted than those that are described here without parting from the spirit and scope of the invention. As will be appreciated by one of ordinary skill in the art, the system may be embodied as a customization of an existing system, an add-on product, and/or a stand-alone system.

As will become apparent from the following descriptions, the present invention enables identifying a leak in various systems. A leak detection system of the present invention includes a boundary containment system and a leak indicator system. The system may be applied to various apparatus, applications and industries such as gas turbines, gas pipelines, pumping stations, pipe systems, and pipe systems containing flanges. Applicable industries include power generation, oil and gas production, shipping, water and sewage, mining, tunneling, commercial and residential gas and propane and the like. The system includes detecting leaks in gas, liquid, or other environments. The system also can operate in high and low temperature environments.

The leak detection system includes any hardware and/or software suitably configured to identify the location of a process leak within a specific boundary. In general, the detection system is implemented to encompass a potential fail point, e.g., a flange in piping, and provide an indicator if the enclosed area reaches a critical leak level. The detection system may be constructed or fabricated from a variety of materials suitable for a particular application of the detection system. Criteria for material selection may include ambient system conditions, chemical conditions, temperature requirements, pressure requirements, flow requirements, or replacement cycle time.

The boundary containment system includes any hardware and/or software suitably configured to encompass a potential fail point and create a sealed boundary so that any material that leaks from the fail point is captured within the boundary containment system. In an exemplary embodiment, the potential fail point is a flange connection within a pipe-based system. In other embodiments, the potential fail point is a suspected weak point within a vessel. In other embodiments, the potential fail point is a tubing connection and/or the various well-known connectors present in tubing systems.

Once a specific boundary is defined, e.g., by sealing a cover over the boundary area, any leakage will leak into a sealed compartment. For example, in a gas pipe system, a boundary containment system may encompass and be sealed around a section of pipe. When the pipe wall fails, water will begin to leak into the sealed compartment of the leak detection system. As a result, this increases the pressure inside the sealed compartment. The boundary containment system may be constructed in as many pieces as necessary to encompass a specific boundary. In an exemplary embodiment, the system is constructed in two pieces. In multiple piece constructions, the pieces may be connected in a variety of ways as long on the attachments are able to secure a sealed environment. In some embodiments, the connections are hinged. In other embodiments, the pieces are connected by compression type fittings. In another embodiment, the system is constructed as one piece. In many embodiments, the piece or pieces are injection molded.

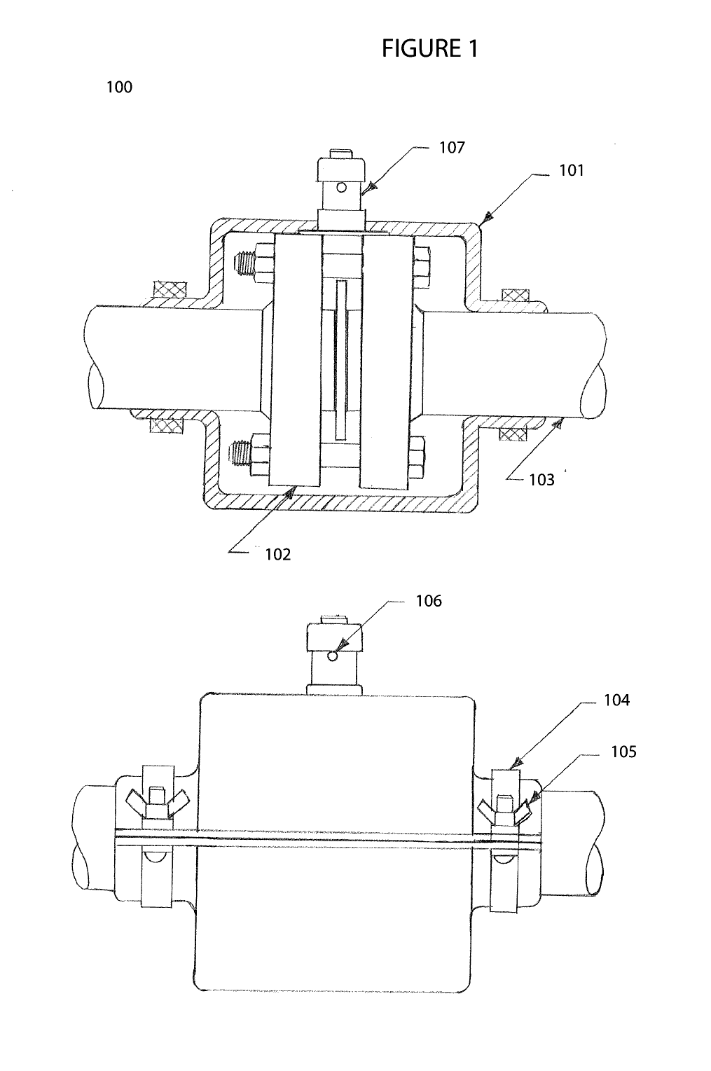

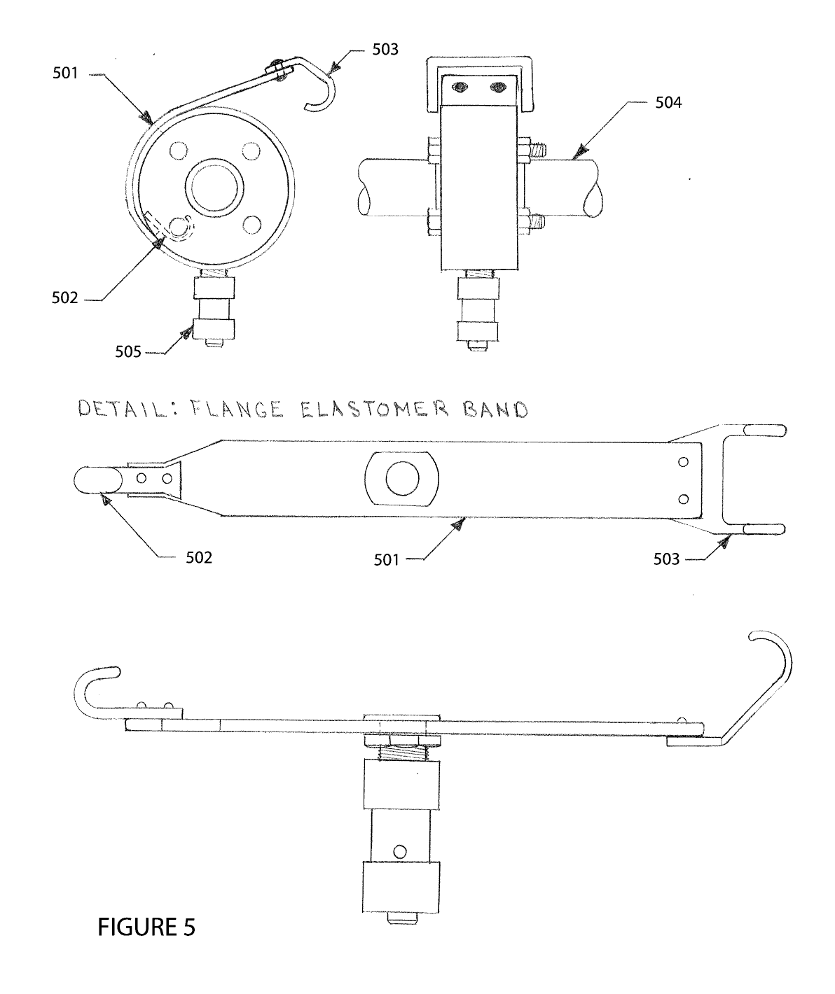

The leak indicator system includes any hardware and/or software suitably configured to indicate pressure changes within the sealed compartment. The leak indicator system is activated when the pressure within the boundary containment system reaches a specified level. Depending on implementation needs, the specified level(s) may be set by an end user. In its embodiments, leaking process within the boundary containment system exerts pressure on a leak indicator, signal, or alert flag, which in turn forces the leak indicator to activate thereby providing notification of a leak within the specific sealed compartment of the boundary containment system. In an exemplary embodiment, the leak indicator is a pin or brass plug, as depicted in FIGS. 1 and 5. In other embodiments, the leak indicator includes a remote monitoring and notification system. Remote monitoring and notification may be accomplished by using pressure switches, pressure transmitters, flow transducers, settable flow switches and the like. The subsystems enable instantaneous notification of a leak to a remote location. In some remote monitoring embodiments, the leak indicator may be an electronic notification at a system monitoring station. Such remote monitoring and notification subsystems are well known and will not be described in detail.

In some embodiments, multiple leak indicators are used to indicate different types of leakage within the boundary containment system. For example, a leak indicator system may employ two indicators: one for flow leakage and another for pressure leakage. In some of these embodiments, each indicator may operate independently or depend on the status of the other. Each indicator, however, is constructed specifically for the type of failure it is tasked to indicate and integrated into the overall system in a similar manner as single indicator systems. In yet other embodiments, one leak indicator may be tasked to indicate multiple types of leaks.

While specific implementations involving a leak detection system are described below, it should be understood that their description is merely illustrative and not intended to limit the scope of the various aspects of the invention.

FIG. 1 illustrates a side view of an exemplary leak detection system 100 of the present invention. The figure shows a potential fail point within a pipe-based system, i.e., a flange on a pipe. The boundary containment system is a flange cover 101 encompassing a flange assembly 102 of a pipe 103. The flange cover 101 is divided into an upper and lower half. The flange cover 101 is sealed to the pipe 103 by pipe clamps 104 and finger nuts 105. By tightening the finger nuts the flange cover 101, the boundary containment system is sealed around the pipes preventing any leakage from the flange assembly 102 except through the leak indicator system 107 at the pressure relief orifice 106.

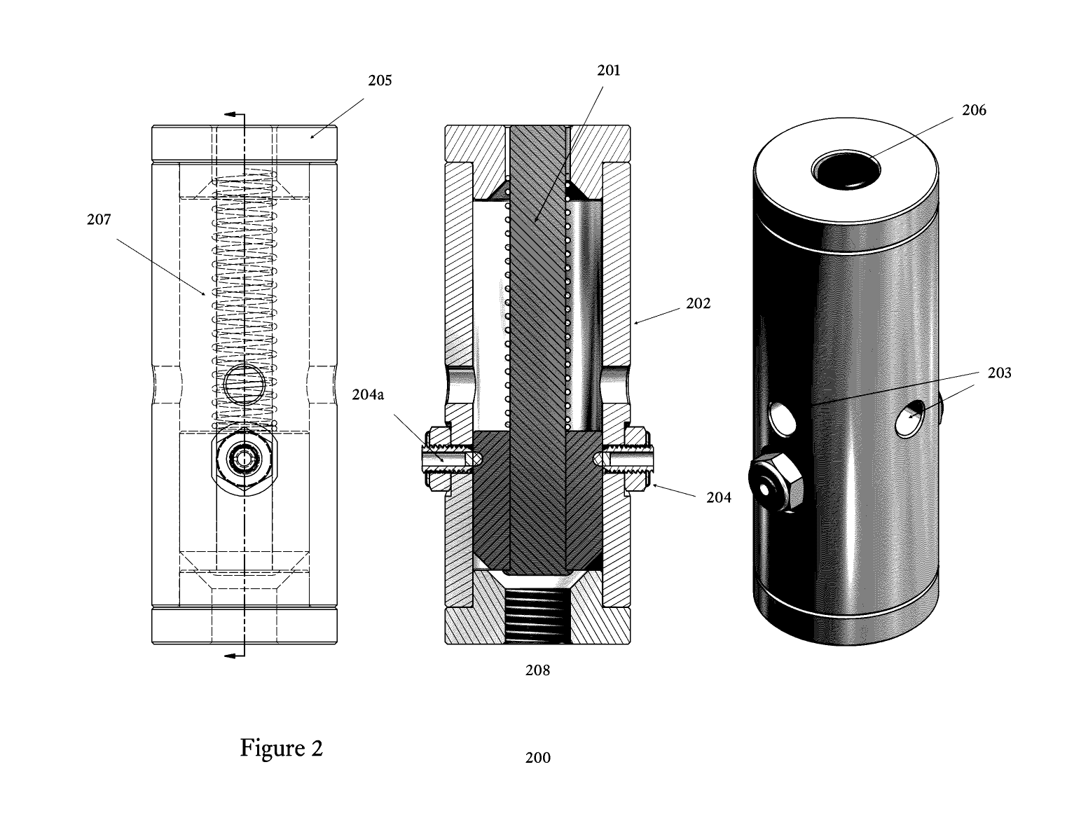

FIG. 2 illustrates a side view of an exemplary leak indicator system of the present invention. When a critical level of pressure is reached within the boundary containment system, the leak indicator system is activated thereby providing notification that a leak has occurred. The leak indicator system 200 includes one or more pressure relief orifices 203 on a cylinder 202. The cylinder 202 is attached to the boundary containment system through a coupling 208. A leak indictor pin (or flag) 201 is situated within the cylinder and a spring 207 is situated around the pin 201 to hold the pin in a closed position. At least a portion of the pin 201 produces a seal with the inside of the cylinder. A spring plunger assembly 204 is coupled to the cylinder 200 so that spring plungers 204 are able to move freely within the spring plunger assembly 204. The spring plungers 204 penetrate the cylinder 202 have access to the inside of the cylinder 200. In this figure, the pin 201 is shown in a position indicated a leak has not yet occurred. Thus, the spring plungers 204a rest against the side of the pin 201. The pin 201 is able to freely move within the cylinder 202 when force is applied to the pin from the bottom or top of the pin. The leak indicator system is coupled to a flange cover assembly or other assembly. The coupling 208 has an opening that enables process to flow up against the bottom of the pin 201 and into the cylinder chamber. A nut 205 is situated at the top of the cylinder 202 to prevent the pin 201 from coming out of the cylinder chamber during operation.

When a leak occurs, process flows into the chamber through the opening in the coupling 208 exerting pressure on the bottom of the pin 201. As pressure increases, the pin 201 rises through the cylinder chamber and out the top of the cylinder 200. Once the pressure from the leaking process forces the pin 201 past the relief orifices 203, process is relieved into the surrounding environment. At this point, the spring plungers 204 are activated and are forced into the cylinder chamber disallowing the pin 201 to recess back into the chamber. A leak indicator 206 is attached, applied or inscribed upon the leak indicator pin 201 that, in this embodiment, indicates a leak has occurred. Any indicator suitably configured for a particular application, such as a blinking light, sound indicator, digital indicator, or the like is within the spirit and scope of the present invention.

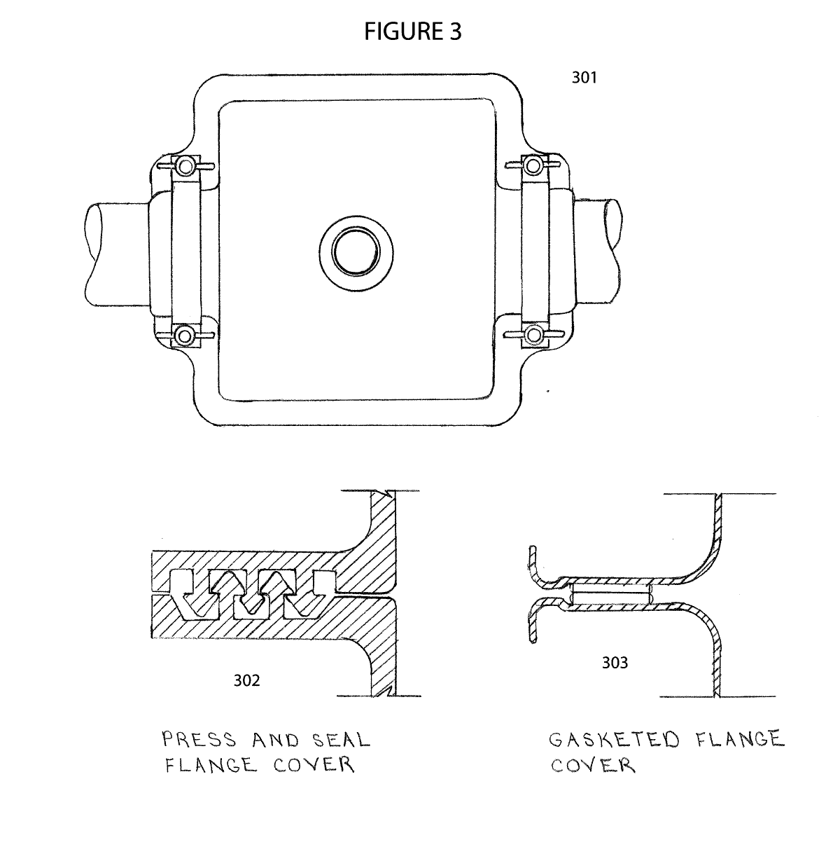

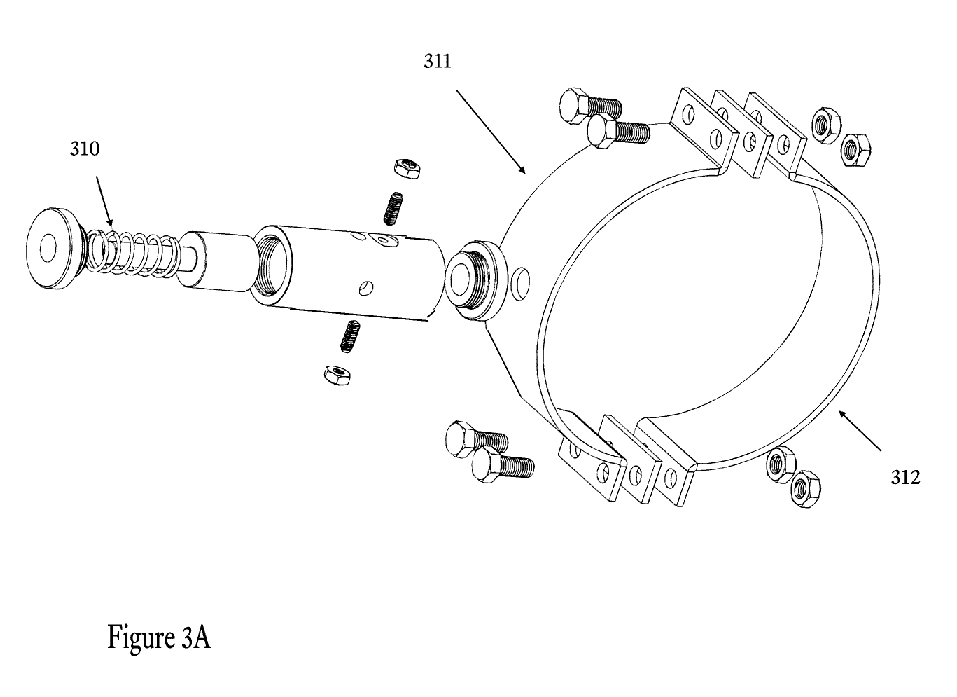

FIG. 3 illustrates exemplary flange seal types of the present invention. In some embodiments utilizing a flange cover, the type of seal configuration depends on the flange cover material. In some embodiments, the upper and lower halves of a flange cover 301 may be sealed with a press and seal configuration 302. In other embodiments utilizing a flange cover, flange cover 301 may be sealed using a gasket configuration 303. For embodiments using injection molded high temperature materials, a preferred configuration is the press and seal configuration 302, which is thermally formed into the upper and lower flange covers. For embodiments in higher pressure or temperature applications, a preferred configuration is a gasket configuration 303, wherein the flange cover is formed from thin gauge metal sheet material and fitted with gaskets. However, any material and configuration that properly seals the boundary containment system for a particular application is within the spirit and scope of the present invention.

The leak indicator system 106 penetrates the flange cover 101 and is sealed to the cover. The seal may be accomplished with a compression type fitting or injection molded to the cover. However, any method of system for providing a seal of the leak indicator system with the boundary containment system is within the scope of the present invention. The leak indicator system 106 includes a leak indicator flag 107 and pressure relief mechanism 108.

FIG. 3A illustrates an exploded view of an alternative embodiment of a flange seal type of the present invention. The leak indicator system 310 is coupled to the top portion 311 of a clamp assembly. This partial assembly is placed on a pipe and seal to the pipe with the bottom portion 312 of the clamp assembly.

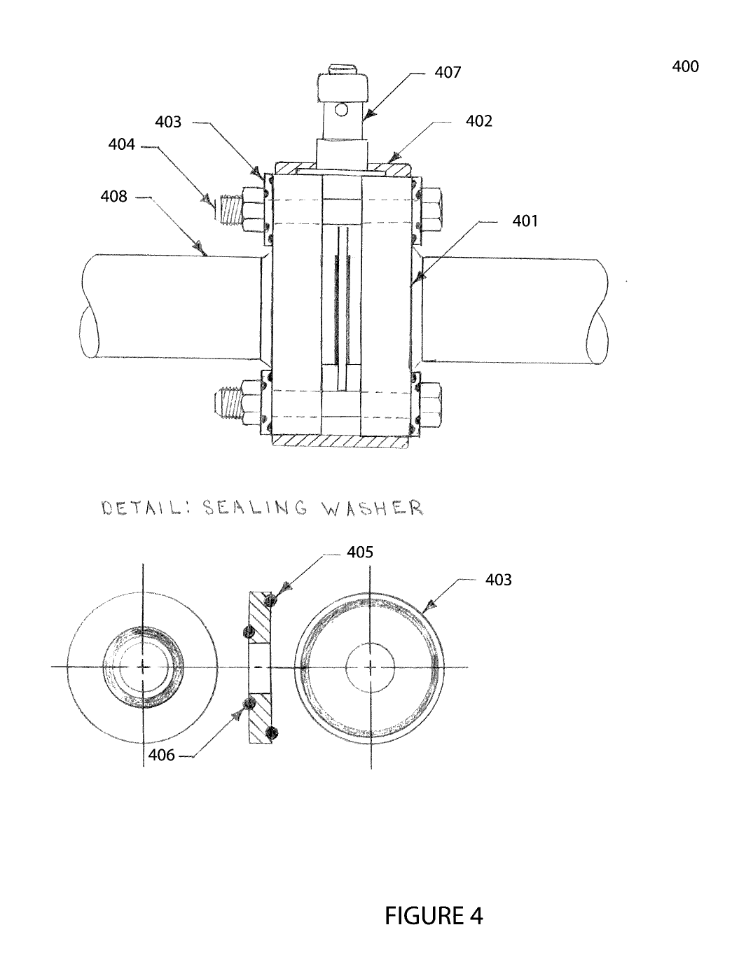

FIG. 4 illustrates an alternative embodiment of a leak detection system 400. The figure shows a potential fail point within a pipe-based system, i.e., a flange assembly 401 on a pipe 408. However, there may be no need or the inability to cover an entire flange assembly. For example, in tight spaces or the ambient environment may not need protection from leaking material. The cavity between the flanges in the flange assembly 401 is sealed creating the boundary containment area by a cover 402. In some embodiments, a hinged cover clamped to the flanges is utilized. In other embodiments, the seal is created with a one-piece cover. In yet another embodiment, the seal is created with a two-piece cover. However, any type of cover configuration and material that seals the cavity between the flanges is suitable and within the spirit and scope of the invention.

The leak detection system includes sealing washers 403 to ensure material does not escape the flange assembly 401 through bolt holes or fasteners 404. The sealing washers 403 are equipped with O-rings on the flange side 405 and on the fastener side 406. In some embodiments, the leak indicator system 407 is sealed to the flange cover 402. In other embodiments, a compression fitting is utilized. The leak indicator system 407 operates as described in FIG. 2.

FIG. 5 illustrates an alternative embodiment of the leak detection system that seals the cavity between flanges in a flange assembly. The boundary containment system is an elastomer band 501. The elastomer band 501 has an inner hook 502 attached to one end of the band and an outer hook 503 attached to the other end of the band. In an exemplary embodiment, the width of the band 501 at the inner hook 502 end is narrower than the remaining part of the band. When the band is wrapped around a pipe 504, the wide portion of the band then creates a seal of the flange assembly cavity by overlapping the narrower region. The band 501 is installed by attaching the inner hook 502 to a fastener of the flange and then wrapping the band around the flanges and attaching the outer hook 503 to the fastener on the outside of the flanges. The leak indicator system 505 is sealed to the band 501 by a compression fitting and operates as described in FIG. 2.

Although the above description may contain specific details, they should not be construed as limiting the claims in any way. Other configurations and equivalents of the described embodiments of the invention are part of the scope of this invention. The descriptions and embodiments are not intended to be an exhaustive or to limit the invention to the precise forms disclosed.

I claim:

1. A leak identification apparatus comprising:
a boundary containment system configured to seal a boundary around an area of interest creating a cavity of constant pressure within the boundary, the area of interest containing a material;
a leak indicator system attached to the boundary containment system configured to maintain the seal around the boundary; and
an indicator situated within the leak indicator system with an inner edge exposed to the cavity of the boundary containment system and an outer edge exposed to an area outside the boundary containment system wherein the indicator is configured to move within the leak indicator system according to the pressure applied to the inner edge and the outer edge.

2. The leak identification apparatus of claim 1 further comprising a pressure relief system attached to the cylinder wherein pressure is released from the boundary containment system when the indicator moves a pre-determined distance.

3. The leak identification apparatus of claim 1 further comprising a remote monitoring system wherein upon activation of the leak indicator system, a notification is sent to the remote monitoring system.

4. The leak identification apparatus of claim 1 wherein the indicator is selected from the group of: an indicator pin, a colored indicator pin, inscribed text on an indicator pin, light, sound, and digital indicator.

5. A leak indicator apparatus comprising:
a cylinder having a cavity extending throughout the cylinder with an upper opening and a bottom opening;
a pressure relief orifice extending through the cylinder such that the orifice is exposed to the cavity and a surrounding environment;
a coupling secured to the bottom opening that enables flow of material through the coupling and the bottom opening into the cavity;
an indicator situated within the cavity, the indicator with an upper edge exposed to the surrounding environment and a bottom edge exposed to the bottom opening wherein the indicator is configured to move within the cavity according to pressure applied to the upper edge and bottom edge;
a spring assembly attached to the cylinder, the spring assembly having a spring plunger situated within the assembly wherein the spring plunger penetrates the cylinder wall and is exposed to the cavity;
the spring plunger configured to move within the spring plunger assembly.

6. The leak indicator apparatus of claim 5 further comprising a spring situated around the pin to prevent movement through the upper opening until sufficient pressure is applied to the bottom edge.

7. The leak indicator apparatus of claim 5 wherein the indicator is selected from the group of: a pin, a colored pin, inscribed text on an pin, light, sound, and digital indicator.

8. The leak indicator apparatus of claim 5 wherein the coupling is configured to screw into a clamp assembly.

9. The leak indicator apparatus of claim 5 further comprising a remote monitoring system wherein a notification is sent to the remote monitoring system upon activation, during, or at the end of the indicator's movement through the cavity.

10. A leak identification apparatus comprising:
a flange assembly in a pipe, the flange assembly having two flanges and secured by one or more bolts;
a cover attached to the flanges of the flange assembly, the cover sealed to the flange assembly creating a cavity of constant pressure between the two flanges;
a sealing washer attached to each bolt, the sealing washer having a first o-ring attached to a first side of the sealing washer and a second o-ring attached to a second side of the sealing washer; and
a leak indicator system sealed to the cover, the leak indicator system comprising:
a coupling sealed to the flange cover;
a cylinder attached to the coupling wherein the cavity is extended into the cylinder;
an indicator situated within the cylinder and coupling, the indicator with an inner edge exposed to the cavity and an outer edge exposed to an area outside of the cover wherein the indicator is configured to move within the coupling and cylinder according to pressure applied to the inner edge and the outer edge;
an o-ring situated around the indicator and within the cylinder, the o-ring maintaining the seal of the cavity.

11. The leak identification apparatus of claim 10 wherein the leak indicator system is attached to the cover by a compression fitting.

12. The leak identification apparatus of claim 10 further comprising an orifice within the cylinder exposing the cylinder to the area outside the cover wherein pressure is released from cavity when the indicator is moved past the orifice to expose the cavity to the area outside the cover.

13. The leak identification apparatus of claim 10 wherein the indicator is selected from the group of: an indicator pin, a colored indicator pin, inscribed text on an indicator pin, light, sound, and digital indicator.

14. The leak identification apparatus of claim 10 further comprising a remote monitoring system wherein upon activation of the leak indicator system, a notification is sent to the remote monitoring system.

15. A leak identification apparatus comprising:
an elastomer band having a narrow end and a wide end;
an inner hook attached to the elastomer band at the narrow end;
an outer hook attached to the elastomer band at the wide end;
a leak indicator system sealed to the elastomer band, the leak indicator system comprising:
a coupling sealed to the elastomer band;
a cylinder attached to the coupling;
an indicator situated within the cylinder and coupling, wherein the indicator is configured to move within the coupling and cylinder according to pressure applied to the inner edge and the outer edge;
an o-ring situated around the indicator and within the cylinder.

16. The leak identification apparatus of claim 15 wherein the indicator is selected from the group of: an indicator pin, a colored indicator pin, inscribed text on an indicator pin, light, sound, and digital indicator.

17. The leak identification apparatus of claim 15 comprising an orifice within the cylinder exposing the cylinder to the area outside the cylinder.

18. The leak identification apparatus of claim 15 further comprising a remote monitoring system wherein upon activation of the leak indicator system, a notification is sent to the remote monitoring system.
